(19) United States
(12) Patent Application Publication
(10) Pub. No.: US 2025/0372825 A1
(43) Pub. Date: Dec. 4, 2025

(54) FLEXIBLE BUSBAR WITH MULTI-FUNCTION LAYERS

(71) Applicant: Manaflex, LLC, Waikoloa, HI (US)

(72) Inventors: Robert C. LANE, Las Vegas, NV (US); Augusto E. BARTON, Pinecrest, FL (US); Yifei LIU, Toronto (CA)

(21) Appl. No.: 19/213,222

(22) Filed: May 20, 2025

Related U.S. Application Data
(60) Provisional application No. 63/652,717, filed on May 29, 2024.

(51) Int. Cl. H01M 50/503; H01M 50/242; H01M 50/522; H01M 50/526

(52) U.S. Cl. CPC H01M 50/503; H01M 50/242; H01M 50/522; H01M 50/526

(57) ABSTRACT

A flexible conductive layer is provided with bending parts for alleviating the expansion force of batteries. It includes multiple layers of stacked conductive layers, with bending parts formed inside the conductive layers to form the bending parts, and intervals set between the bending parts of adjacent conductive layers. The structure is simple, and is formed by stacking multiple layers of conductive layers. The conductive layers can be produced using roll materials and fully automatic circular blade/laser cutting machines, and subsequent processes such as attaching insulation layers can be fully automated, saving labor costs and increasing production efficiency.

### CROSS-REFERENCE TO RELATED APPLICATION

This application is a non-provisional application of, and claims priority to and the benefit of, U.S. Provisional Patent App. No. 63/652,717, entitled “FLEXIBLE BUSBAR WITH MULTI-FUNCTION LAYERS”, filed May 29, 2024, with Attorney Docket No. 4375.0020P, the entire disclosure of which is incorporated by reference herein in its entirety.

### FIELD OF INVENTION

The present invention relates to the field of new energy battery technology, particularly to a flexible conductive layer.

### BACKGROUND

To alleviate the impact of battery expansion force on the connection of busbars, the busbars available in the market are generally thick to ensure strength and prevent the battery expansion force from pulling the conductive layer apart. These conductive layers are typically formed by one-time stamping. After stamping, the conductive layers are manually assembled into finished products such as CCS (Cells Contact System), also known as integrated busbars, wire harness board assemblies, battery cover assemblies, etc., for production. The material cost of stamped conductive layers is high, and the corresponding production cost is also high. Moreover, it is difficult to achieve fully automated production on assembly lines, resulting in low production efficiency. Therefore, there is a need for improvement.

### SUMMARY

The present invention relates to a flexible conductive layer that overcomes the shortcomings of the existing technology.

To achieve the above purpose, this present invention provides the following technical solutions.

This present invention relates a flexible conductive layer, which is equipped with bending portions for alleviating the expansion force of batteries. It includes multiple layers of conductive layers stacked together, with bends formed inside the conductive layers to create the bending portions.

Furthermore, in the aforementioned flexible conductive layer, conductive connection layers are arranged between adjacent conductive layers.

Additionally, in the aforementioned flexible conductive layer, intervals are provided between the bends of adjacent conductive layers.

Moreover, in the aforementioned flexible conductive layer, the conductive connection layers comprise connection pieces located at both ends of adjacent conductive layers. These connection pieces are positioned on both sides of the bending portions, with intervals between the two connection pieces.

Furthermore, in the aforementioned flexible conductive layer, there is also a sensing layer used to sense the temperature and voltage of the flexible conductive layer, and it is electrically connected to a sampling sensing circuit.

Furthermore, in the aforementioned flexible conductive layer, there is also a connection layer where nickel or copper layers are set on the outer side of the outermost conductive layer. When the conductive layer is made of metal such as aluminum, it can be electrically connected to an external circuit through the connection layer.

Furthermore, in the aforementioned flexible conductive layer, there is also a durability layer where single-layer or multi-layer steel plates are set in between any adjacent conductive layers or on the outer side of the outermost conductive layer to improve overall fatigue durability.

In one aspect of the present disclosure, a flexible conductive layer comprises conductive layers stacked together, each of the conductive layers including a bend formed therein that creates a bending part, wherein the bends alleviate an expansion force of batteries to which the conductive layers are coupled.

In one embodiment, the conductive layers are internally provided with bends forming the bending parts.

In another embodiment, a conductive connection layer is located between adjacent conductive layers.

In an alternative embodiment, intervals are set between the bending parts of adjacent conductive layers.

In yet another embodiment, the conductive connection layer comprises two connection pieces respectively set at both ends between adjacent conductive layers, and the two connection pieces are respectively set on both sides of the bending part, with intervals set between the two connection pieces.

In one embodiment, the conductive layers are connected together.

In another embodiment, the conductive connection layer is made of a conductive soldering material.

In an alternative embodiment, gaps are formed between adjacent bends, and the gaps facilitate heat dissipation of the conductive layers.

In yet another embodiment, the flexible conductive layer further comprises a sensing layer which is used to sense a temperature and a voltage of the flexible conductive layer.

In one embodiment, the sensing layer is electrically connected to a sampling sensing circuit.

In another embodiment, the flexible conductive layer further comprises a connection layer that is electrically connected to an external circuit.

In an alternative embodiment, the flexible conductive layer further comprises a durability layer, the durability layer being a steel plate positioned between adjacent conductive layers.

In yet another embodiment, the flexible conductive layer further comprises a durability layer, the durability layer being located on an outer side of an outermost conductive layer to improve fatigue durability.

Compared with conventional systems, the advantages of the present invention are as follows: the structure is simple, which is achieved through stacking multiple layers of conductive layers. The conductive layers can be produced using coil materials and fully automated circular blade/laser cutting machines, and subsequent processes such as insulation layer attachment can be fully automated, saving labor costs and increasing production efficiency. By welding the stacked conductive layers together through the conductive connection layers, the overall strength is ensured. The connection pieces are spaced at the bending portions, creating gaps between adjacent bends, which facilitates bending and promotes heat dissipation of the conductive layers.

### BRIEF DESCRIPTION OF THE DRAWINGS

In order to further illustrate the technical solutions of the embodiments of the present invention more clearly, a brief introduction to the drawings required in the description of the embodiments is provided below. It is evident that the drawings described below are only some embodiments of the present invention. Ordinary skilled artisans in this field can obtain other drawings based on these drawings.

FIG. 1 shows a schematic diagram of the structure of a specific embodiment of the flexible conductive layer according to the present invention.

FIG. 2 shows an exploded schematic diagram of a specific embodiment of the flexible conductive layer according to the present invention.

FIG. 3 shows a schematic diagram of a portion of an embodiment of a flexible conductive layer according to the present invention.

FIG. 4 shows a schematic diagram of a portion of an embodiment of a flexible conductive layer according to the present invention.

FIG. 5 shows a schematic diagram of a portion of an embodiment of a flexible conductive layer according to the present invention.

### DETAILED DESCRIPTION

Below, the technical solutions in the embodiments disclosed herein are described in detail in conjunction with the accompanying drawings. It is evident that the described embodiments are only some of the embodiments of the present invention. Based on the embodiments disclosed herein, all other embodiments obtained by ordinary skilled artisans without creative labor fall within the scope of protection of the present invention.

In the description herein, it should be noted that the terms “center,” “top,” “bottom,” “left,” “right,” “vertical,” “horizontal,” “inner,” “outer,” and other directional or positional relationships are based on the orientation or position shown in the drawings, are solely for the purposes of facilitating the description herein and simplifying the description. It does not indicate or imply that the device or component referred to must have a specific orientation, be constructed or operated in a specific orientation, and therefore should not be understood as limiting the scope of the present invention. Furthermore, the terms “first,” “second,” and “third” are used for descriptive purposes only and should not be construed as indicating or implying relative importance.

In the description herein, it should be noted that unless otherwise specified and limited, the terms “installation,” “connection,” and “linking” should be broadly interpreted. For example, it can be a fixed connection, a detachable connection, or an integral connection; it can be a mechanical connection or an electrical connection; it can be directly connected or indirectly connected through an intermediate medium, or it can be communication between two components. Ordinary skilled artisans in this field can understand the specific meanings of the above terms based on specific circumstances.

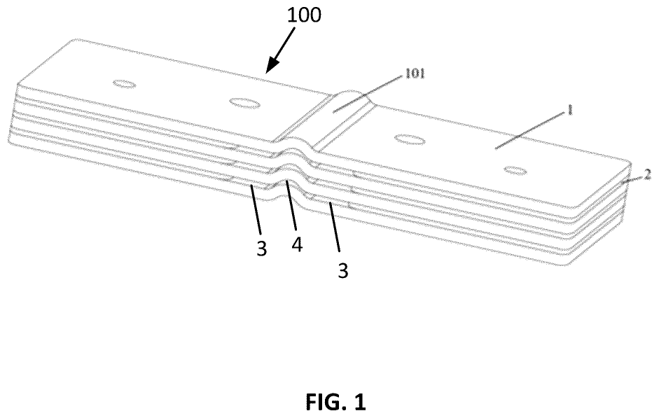

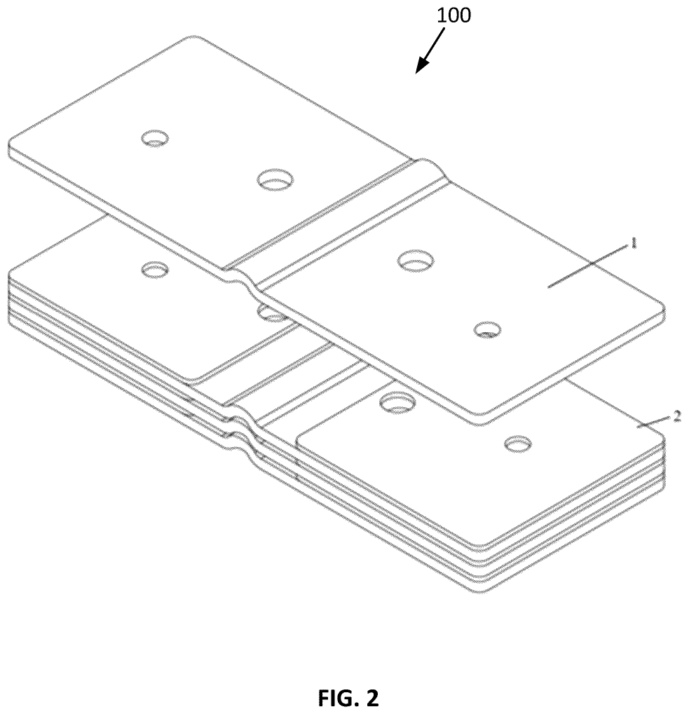

As exemplified by FIGS. 1 and 2, a flexible conductive layer 100 is disclosed, which is equipped with bending portions for alleviating the expansion force of batteries. In one embodiment, it includes multiple layers of conductive layers 1 stacked together, with bends 101 formed inside the conductive layers to create the bending portions. In one embodiment, the conductive layers may be provided with bends.

In this technical solution, the conductive layers are used to connect the positive or negative terminals of batteries and are equipped with positioning holes corresponding to the batteries. In actual applications, to reduce product weight and production costs, the conductive layers can be made of any electrically conducting material, including but not limited to, aluminum, copper, steel, nickel, as well as composite materials and various alloys. The conductive layers can be produced using coil materials and fully automated circular blade/laser cutting machines, and subsequent processes such as attaching insulation layers can be fully automated, saving labor costs and increasing production efficiency. In various embodiments, the layers can be made of the same or different material types.

As shown in FIGS. 1 and 2, conductive connection layers or pieces 2 are arranged between adjacent conductive layers 1.

In this technical solution, the conductive connection layers 2 are made of conductive soldering materials. After the conductive layers 1 and conductive connection layers 2 are stacked, they are rigidly connected as a whole by welding or other methods to meet strength requirements. The conductive connection layers 2 and conductive layers 1 are made of highly conductive metals.

As shown in FIGS. 1 and 2, intervals 3 are provided between the bends 101 of adjacent conductive layers 1.

In this technical solution, gaps 4 are formed between adjacent bends 101, which facilitate heat dissipation of the conductive layers 1.

As shown in FIGS. 1 and 2, the conductive connection layers 2 comprise connection pieces located at both ends of adjacent conductive layers 1. These connection pieces are positioned on both sides of the bending portions, with intervals between the two connection pieces.

In this technical solution, the two connection pieces are spaced at the bending portions, creating gaps at corresponding positions between adjacent conductive layers, facilitating bending. This can be achieved through the use of molds, without the need for punching machines or bending machines. After bending, gaps are formed between adjacent bends, which facilitate heat dissipation of the conductive layers.

In an alternative embodiment, the conductive layers 1 and conductive connection layers 2 are formed without bends.

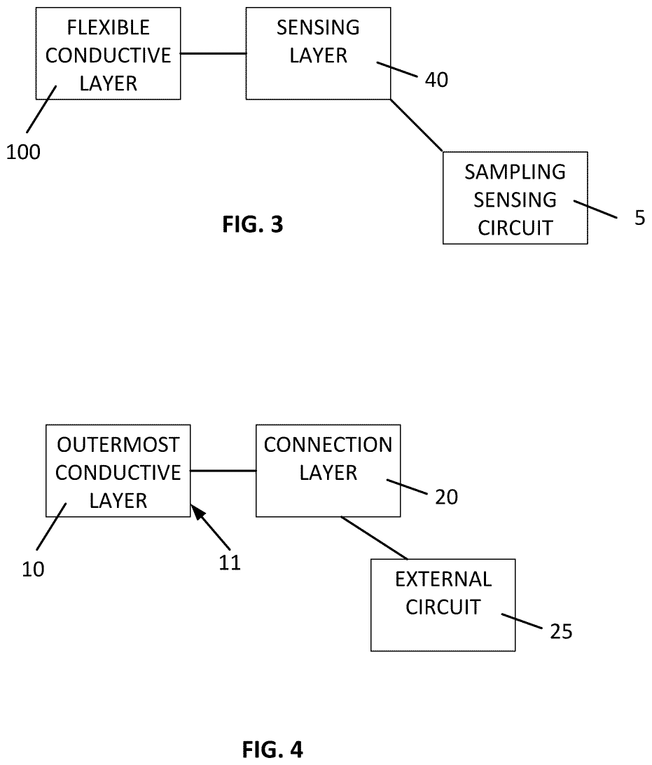

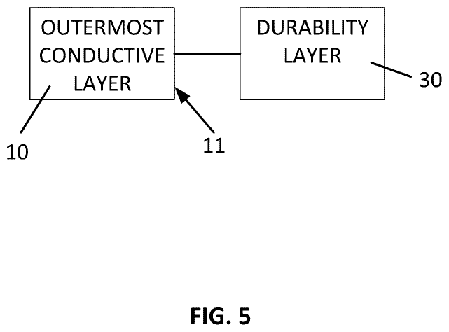

Examples of the above-mentioned flexible conductive layer 100 also include a sensing layer 40, which is used to sense the temperature and voltage of the flexible conductive layer 100 and is electrically connected to a sampling sensing circuit 5. (See FIG. 3)

Examples of the above-mentioned flexible conductive layer 100 also include a connection layer 20, where nickel or copper layers are set on the outer side 11 of the outermost conductive layer 10. When the conductive layer is made of metal such as aluminum, it can be electrically connected to an external circuit 25 through the connection layer 20.

Examples of the above-mentioned flexible conductive layer 100 also include a durability layer 30, where single-layer or multi-layer steel plates are set between any adjacent conductive layers or on the outer side 11 of the outermost conductive layer 10 to improve overall fatigue durability.

In summary, the structure disclosed herein is simple, and is achieved through stacking multiple layers of conductive layers. The conductive layers can be produced using coil materials and fully automated circular blade/laser cutting machines, and subsequent processes such as attaching insulation layers can be fully automated, saving labor costs and increasing production efficiency. By welding the stacked conductive layers together through the conductive connection layers, the overall strength is ensured. The connection pieces are spaced at the bending portions, creating gaps between adjacent bends, which facilitate bending and promote heat dissipation of the conductive layers.

It should be noted that in this document, the terms “including,” “comprising,” or any other variations thereof are intended to encompass non-exclusive inclusion, so that processes, methods, articles, or devices comprising a series of elements include not only those elements, but also other elements not explicitly listed, or even include elements inherent to such processes, methods, articles, or devices. Without further limitations, the elements specified by the phrase “including one . . . ” do not exclude other identical elements in the process, method, article, or device including the specified elements.

The above-described embodiments are only specific implementation methods disclosed herein. It should be pointed out that ordinary skilled artisans in this technical field can make various improvements and modifications without departing from the principles herein. These improvements and modifications should also be considered within the scope of protection disclosed herein.

What is claimed is:

1. A flexible conductive layer, comprising:
conductive layers stacked together, each of the conductive layers including a bend formed therein that creates a bending part, wherein the bends alleviate an expansion force of batteries to which the conductive layers are coupled.

2. The flexible conductive layer of claim 1, wherein the conductive layers are internally provided with bends forming the bending parts.

3. The flexible conductive layer of claim 1, wherein a conductive connection layer is located between adjacent conductive layers.

4. The flexible conductive layer of claim 1, wherein intervals are set between the bending parts of adjacent conductive layers.

5. The flexible conductive layer of claim 3, wherein the conductive connection layer comprises two connection pieces respectively set at both ends between adjacent conductive layers, and the two connection pieces are respectively set on both sides of the bending part, with intervals set between the two connection pieces.

6. The flexible conductive layer of claim 5, wherein the conductive layers are connected together.

7. The flexible conductive layer of claim 5, wherein the conductive connection layer is made of a conductive soldering material.

8. The flexible conductive layer of claim 1, wherein gaps are formed between adjacent bends, and the gaps facilitate heat dissipation of the conductive layers.

9. The flexible conductive layer of claim 1, further comprising:
a sensing layer which is used to sense a temperature and a voltage of the flexible conductive layer.

10. The flexible conductive layer of claim 9, wherein the sensing layer is electrically connected to a sampling sensing circuit.

11. The flexible conductive layer of claim 1, further comprising:
a connection layer that is electrically connected to an external circuit.

12. The flexible conductive layer of claim 1, further comprising:
a durability layer, the durability layer being a steel plate positioned between adjacent conductive layers.

13. The flexible conductive layer of claim 1, further comprising:
a durability layer, the durability layer being located on an outer side of an outermost conductive layer to improve fatigue durability.
